(19) United States
(12) Patent Application Publication
(10) Pub. No.: US 2019/0330742 A1
(43) Pub. Date: Oct. 31, 2019

(54) COLD SPRAY COATING WITH SACRIFICIAL FILLER POWDER

(71) Applicant: Applied Materials, Inc., Santa Clara, CA (US)

(72) Inventors: Xiaowei Wu, San Jose, CA (US); Jennifer Y. Sun, Mountain View, CA (US)

(21) Appl. No.: 15/965,797

(22) Filed: Apr. 27, 2018

(51) Int. Cl. C23C 18/08; C25F 3/02; B01D 46/00; B01D 39/20

(52) U.S. Cl. CPC C23C 18/08; C25F 3/02; B01D 46/0001; B01D 2239/1208; B01D 2239/10; B01D 2239/1216; B01D 39/2051

(57) ABSTRACT

Methods for forming a porous coating with a controlled porosity and pore size are described. The methods include mixing a first powder comprising a first material with a second powder comprising a second material to form a mixed powder comprising 30-99 vol. % of the first powder and 1-70 vol. % of the second powder. The methods further include performing cold spray coating to deposit a coating comprising the first material and the second material onto an article, wherein the coating comprises approximately 30-99 vol. % of the first material and 1-70 vol. % of the second material. The methods further include performing a post-coating process to remove the second material from the coating, wherein after the post-coating process the coating consists essentially of the first material and has a porosity that is approximately equivalent to a volume occupied by the second material prior to the post-coating process.

### TECHNICAL FIELD

Embodiments of the present disclosure relate, in general, to porous coatings and to a process for applying a porous coating by performing cold spray coating with a powder mixture that includes a sacrificial filler powder.

### BACKGROUND

In the semiconductor industry, it can be beneficial to have a porous coating on numerous different chamber components. However, it is generally difficult to accurately control a pore size and porosity of such porous coatings.

### SUMMARY

In one embodiment, a method includes mixing a first powder comprising a first material with a second powder comprising a second material to form a mixed powder, wherein the second powder is a sacrificial filler powder. The mixed powder comprises 30-99 vol. % of the first powder and 1-70 vol. % of the second powder. The method further includes performing cold spray coating to deposit a coating comprising the first material and the second material onto an article. The coating comprises approximately 30-99 vol. % of the first material and 1-70 vol. % of the second material. The method further includes performing a post-coating process to remove the second material from the coating. After the post-coating process, the coating consists essentially of the first material and has a porosity that is approximately equivalent to a volume occupied by the second material prior to the post-coating process, wherein the porosity is about 2-73%.

In one embodiment, a component for a processing chamber (e.g., such as a filter or gas diffuser) comprises a substrate and a porous coating on the substrate. The porous coating may consist of a metal or a metal oxide. The porous coating has a thickness of approximately 1-50 mils, a porosity of about 2-73%, and an average pore size of 10 nm and 40 microns. The component may be manufactured according to methods described herein.

In one embodiment, a filter for a gas delivery system of a processing chamber comprises a substrate and a porous coating on the substrate. The filter may be used at one of multiple different stages of the gas delivery system to filter out particles from gases that flow through the gas delivery system. The porous coating may consist of a metal or a metal oxide. The porous coating has a thickness of approximately 1-50 mils, a porosity of about 2-73%, and an average pore size of 10 nm and 40 microns. The filter may be manufactured according to methods described herein. The filter may be manufactured by a process that includes mixing a first powder comprising the metal or the metal oxide with a second powder comprising a second material to form a mixed powder, wherein the mixed powder comprises 30-99 vol. % of the first powder and 1-70 vol. % of the second powder, and wherein the second powder is a sacrificial filler powder. The process may further include performing cold spray coating to deposit a coating comprising the metal or the metal oxide and the second material onto a substrate, wherein the coating comprises approximately 30-99 vol. % of the metal or metal oxide and 1-70 vol. % of the second material. The process may further include performing a post-coating process to remove the second material from the coating and transform the coating into the porous body, wherein after the post-coating process the porous body consists essentially of the metal or the metal oxide and has a porosity that is approximately equivalent to a volume occupied by the second material prior to the post-coating process. The process may further include removing the substrate from the porous body.

### BRIEF DESCRIPTION OF THE DRAWINGS

The present disclosure is illustrated by way of example, and not by way of limitation, in the figures of the accompanying drawings in which like references indicate similar elements.

FIG. 1 depicts a sectional view of one embodiment of a processing chamber.

FIG. 2 illustrates an exemplary architecture of a manufacturing system, in accordance with one embodiment.

FIG. 3 illustrates a first method of forming a porous coating with a controlled porosity and pore size according to an embodiment.

FIG. 4 illustrates a second method of forming a porous coating with a controlled porosity and pore size according to an embodiment.

FIG. 5 illustrates a third method of forming a porous coating with a controlled porosity and pore size according to an embodiment.

FIG. 6 illustrates a method of manufacturing a component of a processing chamber according to embodiments.

FIG. 7 illustrates various stages of a process for producing a porous coating, according to embodiments.

FIG. 8 illustrates a galvanic series.

### DETAILED DESCRIPTION OF EMBODIMENTS

Embodiments of the disclosure are directed to processes for forming a porous coating with a controlled porosity and a controlled average pore size. Embodiments are also directed to filters, gas diffusers and other chamber components formed using the described processes for forming a porous coating. An article may be cold spray coated with a mixed powder that comprises a coating powder and a sacrificial filler powder. After the coating is completed, a post-coating process may be performed to remove the sacrificial filler powder from the coating. After the post-coating process is complete, the coating may no longer include the sacrificial filler powder. Instead, the volume of the coating that was initially occupied by the sacrificial filler powder may be pores having a pore shape and size that approximately matches a particle shape and size of the sacrificial filler powder that was removed from the coating.

The mixed powder may contain approximately 30-99 vol. % of the coating powder and 1-70 vol. % of the sacrificial filler powder. Similarly, the coating may contain coating approximately 30-99 vol. % of a first material of the coating powder and 1-70 vol. % of a second material of the sacrificial filler powder prior to the post-coating process. After the post-coating removal process is performed, the coating may consist essentially of the first material and may have a porosity that is approximately equivalent to a volume that was occupied by the second material prior to the post-coating process (e.g., a porosity of about 1-70% plus an additional 1-3% introduced by the coating process).

The sacrificial filler powder may be a non-expanding powder in embodiments. Accordingly, the sacrificial filler powder does not cause the coating to expand or foam during the post-coating process. Non-expanding filler powder is used so that the pore size of the porous coating and porosity of the porous coating can be precisely controlled. If the sacrificial filler powder expanded or foamed during the post-coating process, then the resultant coating would have an unpredictable porosity and/or an unpredictable pore size. Additionally, by using non-expanding filler powder the mechanical integrity of the coating is maintained during the post-coating process. Use of an expanding or foaming filler powder would reduce a mechanical strength of the coating and render it unusable for certain applications (e.g., as a gas diffuser or filter).

The pore size of the porous coating can be precisely controlled based on careful selection of an average particle size of the sacrificial filler powder. Additionally, the porosity of the porous coating can be precisely controlled based on careful selection of a ratio of the coating powder to the sacrificial filler powder. Conventional techniques for generating porous coatings are imprecise, and are not generally capable of precisely producing a coating with both a controlled porosity and a controlled pore size.

In embodiments, by precisely controlling the pore size and the porosity of the porous coating, new applications of porous coatings are possible. For example, the porous coating may be deposited over a gas distribution plate to act as a gas diffuser on the gas distribution plate to more evenly distribute the gas across a substrate. In another example, a conventional showerhead and/or gas distribution plate may be entirely replaced with a gas diffuser formed from a porous coating formed in accordance with embodiments described herein. The gas diffuser may be placed in a processing chamber instead of a gas distribution plate and/or instead of a showerhead. In another example, filters for a gas delivery system may be produced using the processes discussed herein. The filters may have a porosity that is selected so as not to impair gas flow and at the same time may have an average pore size that is selected to filter out particles of particular sizes. There are also many other practical applications of porous coatings that have precisely controlled porosity and pore size.

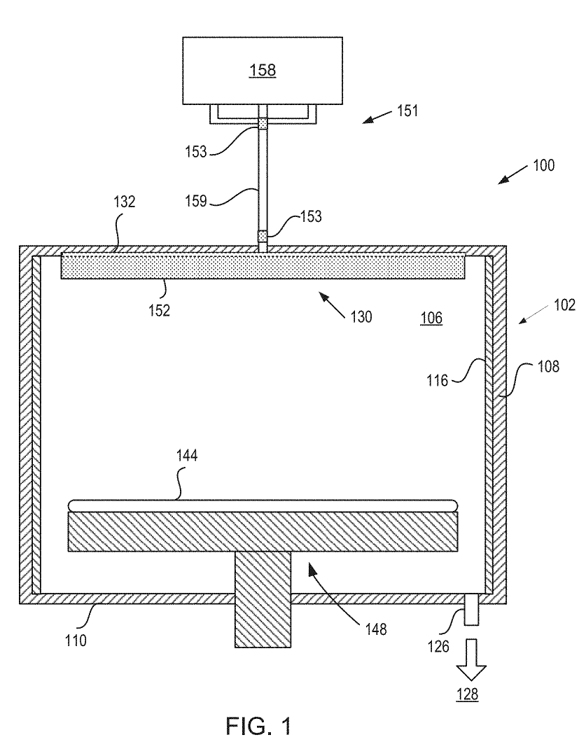

FIG. 1 is a sectional view of a semiconductor processing chamber 100 having one or more chamber components that include and/or are formed from a porous coating with precisely controlled porosity and pore size. The processing chamber 100 may be used, for example, for semiconductor manufacturing processes, display manufacturing processes, micro-electrical mechanical system (MEMS) manufacturing processes, photovoltaic manufacturing processes, and so on. For example, the processing chamber 100 may be a chamber for a plasma etcher or plasma etch reactor, a plasma cleaner, chemical vapor deposition (CVD) reactors, physical vapor deposition (PVD) reactors, atomic layer deposition (ALD) reactors, and so forth.

In an embodiment, one or more articles in the processing chamber 100 may be composed of or include aluminum, an aluminum alloy (e.g., Al 6061, Al 6063, etc.), stainless steel, or any other metal compound. In an embodiment, articles may be composed of or include a solid sintered ceramic body such as Y₂O₃, Al₂O₃, AlN, and Y₃Al₅O₁₂ (YAG).

One or more of the articles in the process chamber 100 include a porous coating that has been deposited in accordance with embodiments of the present disclosure. The porous coating may be a metal coating, a metal oxide coating (e.g., a rare earth metal oxide coating), a metal fluoride coating (e.g., a rare earth metal fluoride coating), or a metal oxy-fluoride coating (e.g., a rare earth metal oxy-fluoride coating). Some example compositions for the porous coating include stainless steel, aluminum, an aluminum alloy, titanium, a titanium alloy, niobium, a niobium alloy, zirconium, a zirconium alloy, copper, or a copper alloy. Other example compositions for the porous coating include Y₂O₃, Al₂O₃, Er₂O₃, YF₃. Y₃Al₅O₁₂ (YAG), Er₃Al₅O₁₂ (EAG), Y—O—F (e.g., Y₅O₄F₇), Er₃Al₅O₁₂ (EAG), Y₄Al₂O₉ (YAM), YAlO₃ (YAP), Er₄Al₂O₉ (EAM), ErAlO₃ (EAP), a solid solution of Y₂O₃—ZrO₂, and a ceramic compound comprising Y₄Al₂O₉ and a solid-solution of Y₂O₃—ZrO₂.

With reference to the solid-solution of Y₂O₃—ZrO₂, the porous coating may include Y₂O₃ at a concentration of 10-90 molar ratio (mol %) and ZrO₂ at a concentration of 10-90 mol %. In some examples, the solid-solution of Y₂O₃—ZrO₂ may include 10-20 mol % Y₂O₃ and 80-90 mol % ZrO₂, may include 20-30 mol % Y₂O₃ and 70-80 mol % ZrO₂, may include 30-40 mol % Y₂O₃ and 60-70 mol % ZrO₂, may include 40-50 mol % Y₂O₃ and 50-60 mol % ZrO₂, may include 60-70 mol % Y₂O₃ and 30-40 mol % ZrO₂, may include 70-80 mol % Y₂O₃ and 20-30 mol % ZrO₂, may include 80-90 mol % Y₂O₃ and 10-20 mol % ZrO₂, and so on.

With reference to the ceramic compound comprising Y₄Al₂O₉ and a solid-solution of Y₂O₃—ZrO₂, in one embodiment the ceramic compound includes 62.93 molar ratio (mol %) Y₂O₃, 23.23 mol % ZrO₂ and 13.94 mol % Al₂O₃. In another embodiment, the ceramic compound can include Y₂O₃ in a range of 50-75 mol %, ZrO₂ in a range of 10-30 mol % and Al₂O₃ in a range of 10-30 mol %. In another embodiment, the ceramic compound can include Y₂O₃ in a range of 40-100 mol %, ZrO₂ in a range of 0.1-60 mol % and Al₂O₃ in a range of 0.1-10 mol %. In another embodiment, the ceramic compound can include Y₂O₃ in a range of 40-60 mol %, ZrO₂ in a range of 35-50 mol % and Al₂O₃ in a range of 10-20 mol %. In another embodiment, the ceramic compound can include Y₂O₃ in a range of 40-50 mol %, ZrO₂ in a range of 20-40 mol % and Al₂O₃ in a range of 20-40 mol %. In another embodiment, the ceramic compound can include Y₂O₃ in a range of 80-90 mol %, ZrO₂ in a range of 0.1-20 mol % and Al₂O₃ in a range of 10-20 mol %. In another embodiment, the ceramic compound can include Y₂O₃ in a range of 60-80 mol %, ZrO₂ in a range of 0.1-10 mol % and Al₂O₃ in a range of 20-40 mol %. In another embodiment, the ceramic compound can include Y₂O₃ in a range of 40-60 mol %, ZrO₂ in a range of 0.1-20 mol % and Al₂O₃ in a range of 30-40 mol %. In other embodiments, other distributions may also be used for the ceramic compound.

Any of the aforementioned porous coatings may include trace amounts of other materials such as ZrO₂, Al₂O₃, SiO₂, B₂O₃, Er₂O₃, Nd₂O₃, Nb₂O₅, CeO₂, Sm₂O₃, Yb₂O₃, or other oxides.

In an embodiment, the processing chamber 100 includes a chamber body 102 that encloses an interior volume 106. The chamber body 102 may be fabricated from aluminum, stainless steel or other suitable material. The chamber body 102 generally includes sidewalls 108 and a bottom 110. An outer liner 116 may be disposed adjacent the sidewalls 108 to protect the chamber body 102. In an embodiment, the outer liner 116 is fabricated from aluminum oxide.

An exhaust port 126 may be defined in the chamber body 102, and may couple the interior volume 106 to a pump system 128. The pump system 128 may include one or more pumps and throttle valves utilized to evacuate and regulate the pressure of the interior volume 106 of the processing chamber 100.

A gas diffuser 130 and/or showerhead (not shown) may be positioned at a top of the chamber body 102. The showerhead and/or gas diffuser 130 may be supported on the sidewall 108 of the chamber body 102. In one embodiment, a showerhead includes a showerhead base and the gas diffuser 130 attached to the showerhead base. Alternatively, the gas diffuser 130 may be used without the showerhead base. The gas diffuser 130 may include a metal mesh substrate 132 and a porous coating 152 formed on the metal mesh substrate 132. Alternatively, the gas diffuser 130 may include a porous coating formed on a porous substrate or a substrate with a plurality of through holes. Alternatively, the gas diffuser 130 may be a porous coating formed on a showerhead base. In one embodiment, the gas diffuser 130 has a thickness of 1-8 mils. Some example thicknesses for the gas diffuser 130 include 2 mils, 4 mils and 6 mils. The gas distribution is controlled by a combination of the thickness of the porous coating of the gas diffuser 130, the porosity of the porous coating and the pore size of the porous coating.

A gas panel 158 may be coupled to the processing chamber 100 via a gas delivery system 151 to provide process and/or cleaning gases to the interior volume 106 through the showerhead and/or gas diffuser 130. The gas diffuser 130 may replace a traditional gas delivery plate (GDP), which typically includes multiple gas delivery holes throughout the GDP. A showerhead may include the gas diffuser 130 coupled to a showerhead base. Alternatively, the gas diffuser 130 may entirely replace a traditional showerhead. Gases and/or plasmas may be flowed through one or more gas delivery lines 159 of the gas delivery system and into the gas diffuser 130. The pores of the gas diffuser 130 serve the same function as gas delivery holes in a GDP. However, for some applications the holes of a GDP cannot be made small enough in a cost effective manner to evenly distribute gas. Gas delivery holes that are too large are a source of deposition non-uniformity on the substrate 144. The gas diffuser 130 may provide a much more uniform gas distribution than a traditional GDP.

The gas diffuser 130 may have a precise porosity and a precise pore size that may diffuse the gas and/or plasma. The diffused gas and/or plasma may then exit the gas diffuser 130 in an approximately uniform manner. Accordingly, an approximately uniform amount of the gas and/or plasma may contact a substrate 144 in the processing chamber 100.

Examples of processing gases that may be used to process substrates in the processing chamber 100 include halogen-containing gases, such as C₂F₆, SF₆, SiCl₄, HBr, NF₃, CF₄, CHF₃, CH₂F₃, F, NF₃, Cl₂, CCl₄, BCl₃ and SiF₄, among others, and other gases such as O₂, or N₂O. Examples of carrier gases include N₂, He, Ar, and other gases inert to process gases (e.g., non-reactive gases).

The gas delivery system 151 may include the gas panel 158, one or more gas delivery lines 159, valves, regulators, and so on. The gas delivery system 151 may additionally include one or more filters 153 at various locations or stages of the gas delivery system 151. For example, filters 153 may be placed in the gas delivery system 151 after a precursor sort and upstream of the processing chamber 100 interior volume 106 but downstream of a main gas line.

Some or all of the filters 153 may be formed in accordance with embodiments herein, and may be based on a porous coating that has a precisely controlled porosity and/or pore size. The filters 153 may have a porosity that does not restrict a gas flow rate. Additionally, the filters 153 may have a pore size and porosity that permits nm-sized particles to pass but that filters out larger particles in an embodiment. For example, the filters 153 may have a porosity and pore size that will filter out any particles larger than 20 nm, 30 nm, 50 nm, 100 nm, 200 nm, or 500 nm in embodiments.

In an example, for atomic layer deposition (ALD) chambers, the gas delivery system 151 may flow nitrogen, precursors for metal oxide deposition and/or metal nitride deposition, precursors for silicon nitride deposition and/or silicon oxide deposition (e.g., trichlorosilane (TCS), dichlorosilane (DCS), silane, etc.), oxygen, water vapor, ozone, ammonium, nitrogen radicals, and so on. Filters 153 may have a porosity and pore size that is appropriate to pass these precursors and reactants but to block particles that they might carry (e.g., from chemical mixtures that take place in the gas delivery lines 159). For example, residual silicon precursors may mix with oxygen reactants or nitrogen reactants in the gas lines 159 to form silicon nitride or silicon oxide particles. The filters 153 may filter out such particles and prevent them from entering the interior volume 106 of the processing chamber 100.

A substrate support assembly 148 is disposed in the interior volume 106 of the processing chamber 100 below the showerhead and/or gas diffuser 130. The substrate support assembly 148 holds a substrate 144 during processing.

An inner liner may be coated on the periphery of the substrate support assembly 148. The inner liner may be a halogen-containing gas resistant material such as those discussed with reference to the outer liner 116. In an embodiment, the inner liner may be fabricated from the same materials of the outer liner 116.

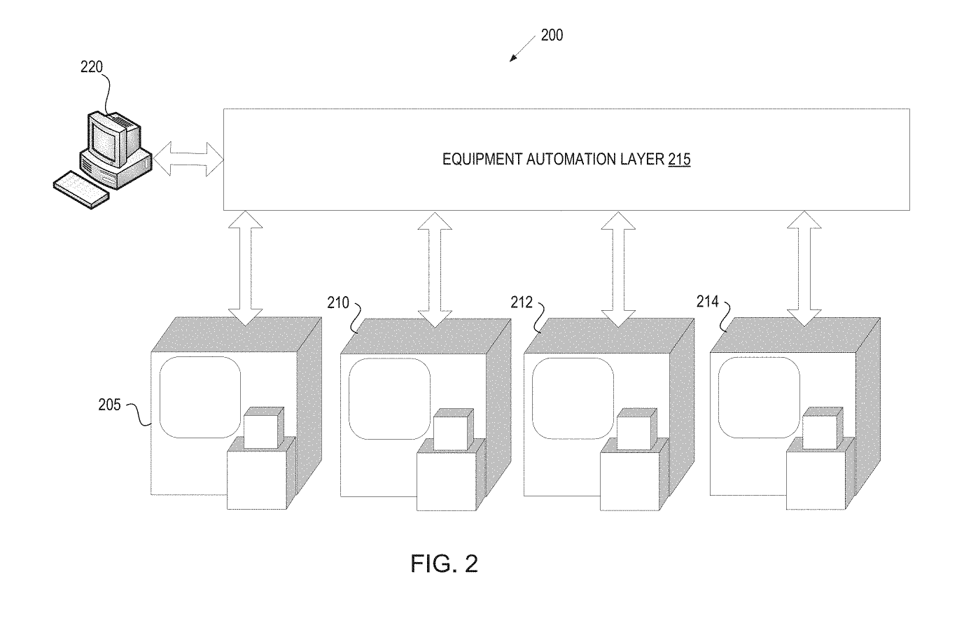

FIG. 2 illustrates an example architecture of a manufacturing system 200. The manufacturing system 200 may be a manufacturing system for manufacturing articles that include a porous ceramic coating with a precisely controlled porosity and/or pore size. In an embodiment, the manufacturing system 200 includes a furnace 205 (e.g., a ceramic furnace such as a kiln or a thermal reactor), a wet cleaner 210, a cold spray deposition system 212, a bead blaster 214, an equipment automation layer 215 and a computing device 220. In alternative embodiments, the manufacturing system 200 may include more or fewer components. For example, the manufacturing system 200 may include a wet etch machine and/or a bath for performing electrochemical reactions (e.g., oxidation-reduction reactions or galvanic reactions) instead of or in addition to the furnace. In another example, the manufacturing system 200 may include the furnace 205, the cold spray deposition system 212, the a bead blaster 214 and the wet cleaner 210, which may be manual off-line machines.

Furnace 205 is a machine designed to heat articles such as metal or ceramic articles. Furnace 205 includes a thermally insulated chamber, or oven, capable of applying a controlled temperature on articles (e.g., ceramic articles) inserted therein. In an embodiment, the chamber is hermitic ally sealed. Furnace 205 may include a pump to pump air out of the chamber, and thus to create a vacuum within the chamber. Furnace 205 may additionally or alternatively include a gas inlet to pump gasses (e.g., inert gasses such as Ar or N₂ or combustible gases such as air or O₂) into the chamber.

Furnace 205 may be a manual furnace having a temperature controller that is manually set by a technician during processing of ceramic articles. Furnace 205 may also be an off-line machine that can be programmed with a process recipe. The process recipe may control ramp up rates, ramp down rates, process times, temperatures, pressure, gas flows, and so on. Alternatively, furnace 205 may be an on-line automated furnace that can receive process recipes from computing devices 220 such as personal computers, server machines, etc. via an equipment automation layer 215. The equipment automation layer 215 may interconnect the furnace 205 with computing devices 220, with other manufacturing machines, with metrology tools and/or other devices.

Wet cleaner 210 is a cleaning apparatus that cleans articles using a wet clean process. The wet cleaner 210 includes a wet bath filled with liquid, in which an article is immersed to clean the article. The wet cleaner 210 may agitate the wet bath using ultrasonic waves during cleaning to improve a cleaning efficacy. This is referred to herein as sonicating or ultrasonicating the wet bath. In an embodiment, the wet cleaner 210 includes a bath of deionized (DI) water.

Bead blaster 214 is a machine configured to roughen the surface of articles. Bead blaster 214 may be a bead blasting cabinet, a hand held bead blaster, or other type of bead blaster. Bead blaster 214 may roughen an article or substrate by bombarding the article or substrate with beads or particles. In one embodiment, bead blaster 214 may fire ceramic beads or particles or salt particles at the article or substrate. The roughness achieved by the bead blaster 214 may be based on a force used to fire the beads, bead materials, bead sizes, distance of the bead blaster from the substrate or article, processing duration, and so forth. The term substrate is used herein to refer to any article, component or body having a surface on which a porous coating is deposited.

In alternative embodiments, other types of surface rougheners than a bead blaster 214 may be used. For example, a motorized abrasive pad may be used to roughen the surface of ceramic substrates. A sander may rotate or vibrate the abrasive pad while the abrasive pad is pressed against a surface of the ceramic article. A roughness achieved by the abrasive pad may depend on an applied pressure, on a vibration or rotation rate and/or on a roughness of the abrasive pad.

Cold spray deposition system 212 is a system that performs cold spray coating processes. Cold spraying is a deposition process that uses kinetic energy rather than thermal energy to form a coating. In cold spray coating, powder particles are accelerated to very high velocities (e.g., of about 200-1200 meters per second) by a supersonic compressed gas jet at temperatures below their melting point. Upon impact with the substrate, the particles experience extreme and rapid plastic deformation which disrupts the thin surface oxide films that are present on all metals and alloys. This allows intimate conformal contact between the exposed metal surfaces under high local pressure, permitting bonding to occur and thick layers of deposited material to be built up rapidly. The deposition efficiency is very high, above 90% in some cases. With cold spray deposition, materials can be deposited without high thermal loads, producing coatings with low porosity and oxygen content. Accordingly, the coatings initially generated by the cold spray deposition system 212 may have a low porosity. The coatings may then undergo post coating processes to transform them into highly porous coatings.

Cold spray deposition system 212 includes a deposition chamber, which can include a stage (or fixture) for mounting a substrate. Air pressure in the deposition chamber can be reduced via a vacuum system to avoid oxidation in some embodiments. The cold spray deposition system 212 includes a gun or nozzle that outputs a high velocity carrier gas. The mixed powder can be output into the high velocity carries gas and propelled onto the target substrate. The mixed powder being cold spray coated on to the article can have a velocity in a range from about 100 m/s to about 1500 m/s and can be sprayed via a carrier gas of nitrogen or argon in embodiments. The coating can have a thickness in a range from about 1-50 mils. In one embodiment, the coating has a thickness of 1-8 mils.

Surfaces of the article or substrate that is coated can be coated evenly because the article and/or the nozzle of the cold spray deposition system 212 can be manipulated to achieve an even coating. In one embodiment, the cold deposition system 212 can have a fixture or stage with a chuck to hold the article during coating.

The stage can be moveable stage (e.g., motorized stage) that can be moved in one, two, or three dimensions, and/or rotated/tilted about in one or more directions. Accordingly, the stage can be moved to different positions to facilitate coating of the substrate with the mixed powder being propelled from the nozzle in a carrier gas. For example, since application of the coating via cold spray is a line of sight process, the stage can be moved to coat different portions or sides of the substrate. If the substrate has different sides that need to be coated or a complicated geometry, the stage can adjust the position of the substrate with respect to the nozzle so that the whole assembly can be coated. In other words, the nozzle can be selectively aimed at certain portions of the substrate from various angles and orientations. In one embodiment, the stage can also have cooling or heating channels to adjust the temperature of the article during coating formation.

In one embodiment, the deposition chamber of the cold spray deposition system 212 can be evacuated using the vacuum system, such that a vacuum is present in the deposition chamber. For example, pressure within the deposition chamber may be reduced to less than about 0.1 mTorr. Providing a vacuum in the deposition chamber can facilitate application of the coating. For example, the mixed powder being propelled from the nozzle encounters less resistance as the mixed powder travels to the substrate when the deposition chamber is under a vacuum. Therefore, the mixed powder can impact the substrate at a higher rate of speed, which facilitates adherence to the substrate and formation of the coating and can help to reduce the level of the oxidation of high purity metal materials like aluminum.

A gas container may hold a pressurized carrier gas, such as nitrogen or argon. The pressurized carrier gas travels under pressure from the gas container to a powder chamber. As the pressurized carrier gas travels from the powder chamber to the nozzle, the carrier gas propels some of the mixed powder towards the nozzle. In one example, the gas pressure can be in a range from about 50 to about 1000 Psi.

In one embodiment, a gas temperature for the carrier gas is in a range from about 100 to about 1000 degrees Celsius (C). In another example, a gas temperature is in a range from about 325 to about 500 degrees C. In one embodiment, a temperature of the gas at the nozzle is in a range from about 120 to about 200 degrees C. The temperature of the mixed powder impacting the substrate can depend on the gas temperature, travel speed, and the size of the substrate.

In one embodiment, the mixed powder has a certain fluidity. In one example, the particles of the first powder can have an average diameter in a range from about 1 microns to about 200 microns and the powders of the second powder can have an average diameter in a range from about 10 nm to 40 microns.

As the carrier gas propelling a suspension of the mixed powder enters the deposition chamber from an opening in the nozzle, the mixed powder is propelled towards the substrate. In one embodiment, the carrier gas is pressurized such that the mixed powder is propelled towards the substrate at a rate of around 100 m/s to about 1500 m/s. For example, the mixed powder can be propelled towards the substrate at a rate of around 300 to around 800 m/sec.

In one embodiment, the nozzle stand-off (i.e., the distance from the nozzle to the substrate) can be in a range from about 5 mm to about 200 mm. For example, the nozzle stand-off can be in a range from about 10 mm to about 50 mm.

Upon impacting the substrate, the particles of the mixed powder fracture and deform from the kinetic energy to produce an anchor layer that adheres to the substrate. As the application of the mixed powder continues, the particles become a cold spray coating or film by bonding to themselves. The cold spray coating on the substrate continues to grow by continuous collision of the particles of the mixed powder on the substrate. In other words, the particles are mechanically colliding with each other and the substrate at a high speed to break into smaller pieces to form a dense layer. Notably, with cold spraying the particles may not melt and reflow.

The cold spray deposition system 212 may be configured to perform cold spray coating to deposit a mixed powder that includes a coating powder as well as a sacrificial filler powder. The coating powder may be or include stainless steel, aluminum, an aluminum alloy, titanium, a titanium alloy, niobium, a niobium alloy, zirconium, a zirconium alloy, copper, a copper alloy, yttrium, a yttrium alloy, or any other material described herein above for the coating powder. The sacrificial filler powder may include aluminum, aluminum oxide, yttrium, yttrium oxide, a plastic, a polymer, or any other material described herein above for the sacrificial filler powder. Any of the possible coating powders and sacrificial filler powders discussed elsewhere herein may be used to form the mixed powder. In embodiments, cold spray deposition system 212 performs a cold spray process to deposit a coating comprising a mixture of a first material from the coating powder and a second material from the sacrificial filler powder.

Further processing may be performed to transform the cold spray coating into a porous coating, such as a heat treatment process performed by heater 205, a chemical removal process performed by a wet etch machine (not shown) or dry etch machine (not shown) or an electrochemical removal process performed by an electrolysis machine (not shown).

In one embodiment, the article can be baked (or thermally treated) in heater 205 for a certain period after the cold spray coating is formed. For example, the article may be thermally treated for 0.5 hours to 12 hours at a temperature between about 100 degrees C. to about 1500 degrees C. (e.g., or about 200 degrees C. to about 1000 degrees C.), depending on the first material of the coating powder, the second material of the sacrificial filler powder and a substrate material. This thermal treatment can perform pyrolysis to burn off the sacrificial filler powder from the coating deposited by the cold spray process. The heat treatment may be performed at a temperature that is below the melting temperature of the first material (e.g., of the coating powder) but that is above the temperature at which pyrolysis of the second material (e.g., of the sacrificial filler powder) is achieved.

In one embodiment, the article and coating are immersed in a bath of acid of a wet etch machine to chemically remove the second material of the sacrificial filler powder from the coating. The acid may be, for example, nitric acid, phosphoric acid, hydrochloric acid, hydrofluoric acid, and so on. An acid may be selected that selectively removes (e.g., dissolves) the second material of the sacrificial filler powder but not the first material of the coating powder. For example, the first material may be stainless steel, the second material may be alumina (Al₂O₃) or yttria (Y₂O₃) and the acid may be nitric acid (HNO₃). The nitric acid may dissolve the alumina or yttria but not the stainless steel. In another example, the first material may be stainless steel, the second material may be silicon dioxide (SiO₂) and the acid may be hydrofluoric acid (HF). The hydrofluoric acid may dissolve the silicon dioxide but not the stainless steel.

In one embodiment, the article and coating are immersed in a bath of a basic solution such as NaOH. The NaOH acid solution may be used, for example, to dissolve a second material of Al₂O₃.

In one embodiment, the article and coating are immersed in a bath of an electrolyte in an electrolysis machine to electrochemically remove the second material of the sacrificial filler powder from the coating. The electrolyte may be, for example, sodium chloride (salt water) or an acid such as nitric acid, phosphoric acid, hydrochloric acid, or hydrofluoric acid. All metals have different electrode potentials. These electrode potentials put each metal in a hierarchy of activity, with the most active metals at the top of the lists, and the least active at the bottom. This order of electrochemical activity is called the Galvanic Series. A metal higher in the Galvanic Series will corrode preferentially to a metal below it in the Galvanic Series. The greater the distance apart the metals are in the Galvanic Series, the higher the current that will flow between them if they are connected in the presence of an electrolyte (a conducting solution; usually water-containing dissolved salts).

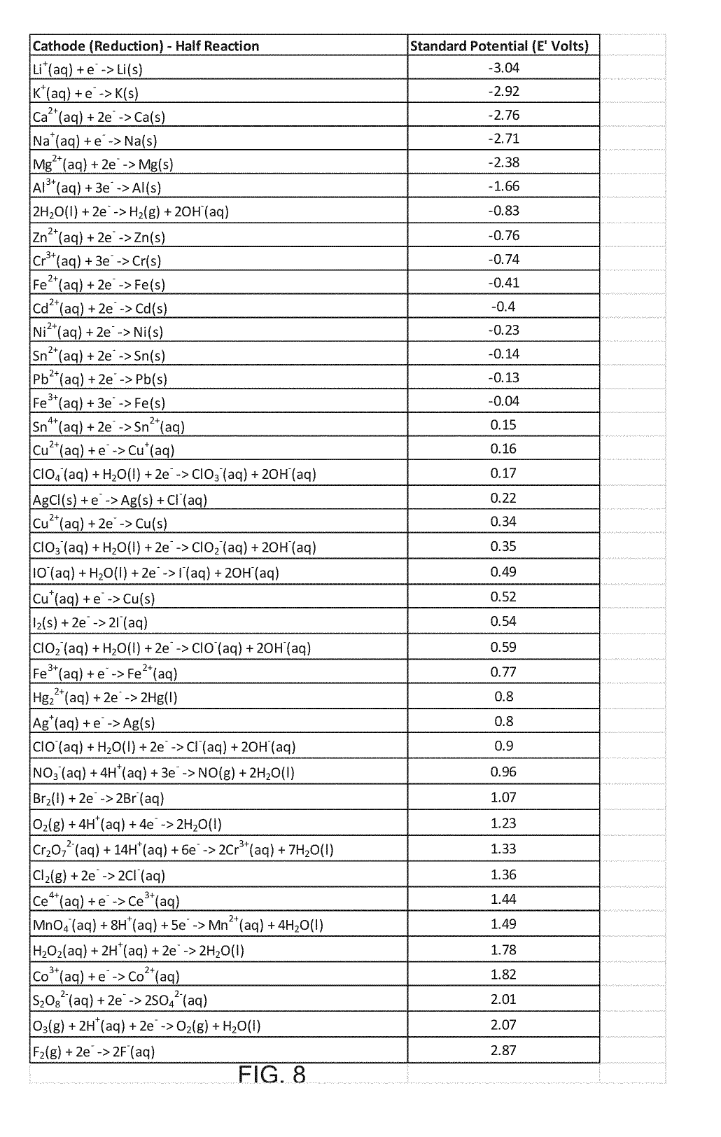

An example Galvanic Series is shown in FIG. 8. The first material may be a first metal in the Galvanic Series and the second material may be a second metal that is higher than the first metal in the Galvanic Series. Accordingly, the second material of the sacrificial filler powder may have a lower electrode potential (a more negative electrode potential) than the first material of the coating powder. When the coating is immersed in the electrolyte, the electrode potential difference between the two materials in the coating generates a voltage and causes a galvanic corrosion or reduction-oxidation (redox) reaction to remove the second material from the coating. The redox reaction is driven by the electrode potential difference between the two materials and results in the sacrificial material (from the sacrificial filler powder) being consumed. Once the sacrificial material is consumed, there is no electrode potential difference in the coating any longer, and the reaction stops.

Returning to FIG. 2, the equipment automation layer 215 may include a network (e.g., a location area network (LAN)), routers, gateways, servers, data stores, and so on. The furnace 205, the wet cleaner 210, the cold spray deposition system 212, the bead blaster 214, and so on may connect to the equipment automation layer 215 via a SEMI Equipment Communications Standard/Generic Equipment Model (SECS/GEM) interface, via an Ethernet interface, and/or via other interfaces. In an embodiment, the equipment automation layer 215 enables process data (e.g., data collected by furnace 205 during a process run) to be stored in a data store (not shown). In an alternative embodiment, the computing device 220 connects directly to the furnace 205 and/or the wet cleaner 210.

In an embodiment, the furnace 205, the wet cleaner 210, the cold spray deposition system 212, the bead blaster 214 and/or one or more other manufacturing machines includes a programmable controller that can load, store and execute process recipes. The programmable controller may control temperature settings, AC currents, energy settings, gas and/or vacuum settings, time settings, etc. of heat treatment processes. The programmable controller may control a heat up, may enable temperature to be ramped down as well as ramped up, may enable multi-step heat treating to be input as a single process, and so forth. The programmable controller may control the gun distance, angle of incidence, gas flow rate, powder feed rate, deposition time, gun movement pattern, and so on of cold spray deposition processes. The programmable controller may include a main memory (e.g., read-only memory (ROM), flash memory, dynamic random access memory (DRAM), static random access memory (SRAM), etc.), and/or a secondary memory (e.g., a data storage device such as a disk drive). The main memory and/or secondary memory may store instructions for performing heat treatment processes described herein.

The programmable controller may also include a processing device coupled to the main memory and/or secondary memory (e.g., via a bus) to execute the instructions. The processing device may be a general-purpose processing device such as a microprocessor, central processing unit, or the like. The processing device may also be a special-purpose processing device such as an application specific integrated circuit (ASIC), a field programmable gate array (FPGA), a digital signal processor (DSP), network processor, or the like. In an embodiment, programmable controller is a programmable logic controller (PLC).

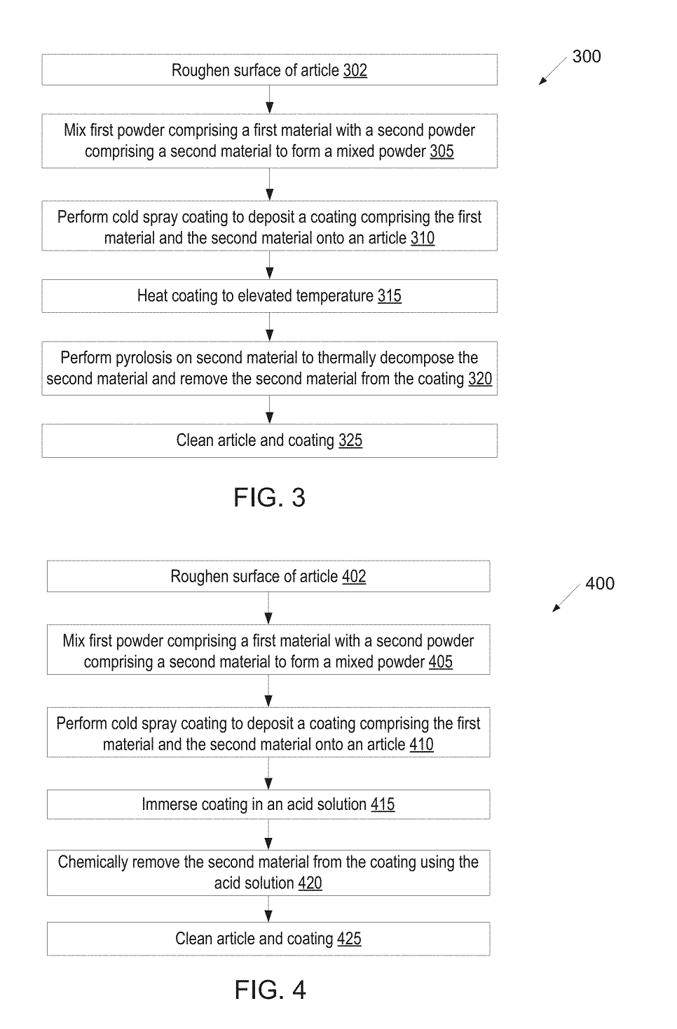

In an embodiment, the furnace 205, the wet cleaner 210, the cold spray deposition system 212, the bead blaster 214, and/or other manufacturing machines are programmed to execute a recipe or sequence of recipes that will cause these manufacturing machines to perform various steps in the processes described below with reference to FIGS. 3-6.

FIG. 3 illustrates a first process 300 for forming a porous coating with a controlled porosity and pore size according to an embodiment. At block 302, a surface of an article may be roughened or otherwise adjusted. The article may be a component for use in a processing chamber (e.g., of semiconductor manufacturing equipment). For example, the component can be a showerhead, a showerhead base, a cathode sleeve, a sleeve liner door, a cathode base, a chamber liner, an electrostatic chuck, etc. The article may also be a substrate such as a metal mesh, a porous substrate, a substrate with a plurality of holes, or a substrate that will be removed after the deposition process. The article may be formed from a metal, metal alloy, oxide (e.g., rare earth oxide), nitride or other material. For example, the substrate can be formed from aluminum, aluminum alloys (e.g., Al 6061, Al 5058, etc.), stainless steel, titanium, titanium alloys, magnesium, magnesium alloys, SiN, SiO₂, AlN, Al₂O₃, and so on.

In one embodiment, the average surface roughness of the article is adjusted prior to the formation of the cold spray coating. For example, an average surface roughness of the article may be in a range from about 15 micro-inches to about 300 micro-inches. In one embodiment, the article has an average surface roughness that starts at or that is adjusted to about 120 micro-inches. The average surface roughness may be increased (e.g., by bead blasting or grinding), or may be decreased (e.g., by sanding or polishing). However, the average surface roughness of the article may already be suitable for cold spray coating. Accordingly, average surface roughness adjustment can be optional.

At bock 305, a first powder (coating powder) comprising a first material and a second powder (sacrificial filler powder) comprising a second material are selected. The first powder may be composed of a first material, which may be any of the materials described herein above for the coating powder. The second powder may be composed of a second material, which may be any of the materials described above for the sacrificial filler powder that can be removed by pyrolysis. In one embodiment, the second material is a carbon-based material selected from a group consisting of a plastic, an epoxy, graphite, and a polymer. Examples of polymers that may be used include polyvinyl butryal (PVB), polyvinyl acetate (PVA), polystyrene (PS), and so on.

The first material may have a first average particle size (e.g., diameter) and the second material may have a second average particle size (e.g., diameter). The second average particle size of the second material may be selected based on a target average pore size for a porous coating to be formed. A ratio of the vol. % of the first powder and the vol. % of the second powder is selected. The ratio of the amount of first powder to the amount of the second powder will control the ultimate porosity of the porous coating. In one embodiment, the porosity of the coating is approximately equal to the ratio of the vol. % of the first powder to the vol. % of the second powder. In one embodiment, the porosity of the coating is directly correlated to the ratio of the vol. % of the first powder to the vol. % of the second powder, and a model can be generated that correlates the vol. % of the second powder to the final porosity of the coating.

The amount of the first powder may be about 30-99 vol. % and the amount of the second powder may be about 1-70 vol. % in embodiments. Some example amounts of the first material include 30 vol. %, 32 vol. %, 35 vol. %, 38 vol. %, 40 vol. %, 42 vol. %, 45 vol. %, 48 vol. %, 50 vol. %, 52 vol. %, 55 vol. %, 58 vol. %, 60 vol. %, 62 vol. %, 65 vol. %, 68 vol. %, 70 vol. %, 72 vol. %, 75 vol. %, 78 vol. %, 80 vol. %, 82 vol. %, 85 vol. %, 88 vol. %, 90 vol. %, 92 vol. %, 95 vol. %, 98 vol. %, and 99 vol. %. Some example amounts of the second material include 1 vol. %, 2 vol. %, 5 vol. %, 8 vol. %, 10 vol. %, 12 vol. %, 15 vol. %, 18 vol. %, 20 vol. %, 22 vol. %, 25 vol. %, 28 vol. %, 30 vol. %, 32 vol. %, 35 vol. %, 38 vol. %, 40 vol. %, 42 vol. %, 45 vol. %, 48 vol. %, 50 vol. %, 52 vol. %, 55 vol. %, 58 vol. %, 60 vol. %, 62 vol. %, 65 vol. %, 68 vol. %, and 70 vol. %. The selected amounts of the first powder and the second powder are then mixed. The powders can be mixed, for example, by ball milling.

At block 310, the article is loaded into a deposition chamber of a cold spray deposition system (e.g., as described above). A cold spray coating process is then performed to deposit a coating comprising the first material of the first powder and the second material of the second powder onto the article. The cold spray coating can have a thickness in a range from about 1-8 mils or about 1-50 mils (e.g., 0.2 mm, 0.4 mm, 0.5 mm, 1 mm, 2 mm, etc.) in embodiments. In one embodiment, a coating deposition rate can be in a range from about 1 to about 50 grams/min. For example, the coating deposition rate can be in a range from about 1 to about 20 grams/min for the mixed powder. Denser coatings can be achieved by a slower feed and faster raster (i.e., travel speed). In one embodiment, efficiency of the deposition process is in a range from about 10 percent to about 90 percent. For example, efficiency can be in a range from about 30 percent to about 70 percent. Higher temperature and higher gas pressure can lead to higher efficiency.

Unlike application of a coating via plasma spray (which is a thermal technique performed at elevated temperatures), application of a cold spray coating via one embodiment can be performed at room-temperature or near room temperature. For example, application of the cold spray coating can be performed at around 15 degrees C. to about 100 degrees C., depending on the gas temperature, travel speed, and size of the article. In the case of a cold spray deposition, the substrate may not be heated and the application process does not significantly increase the temperature of the substrate being coated.

In one embodiment, the cold spray coating can be very dense, e.g., greater than about 99% density. In other embodiments, the cold spray coating has a porosity of about 1-3%. Further, the cold spray coating can have good adhesion to the substrate without inter-layers, e.g. about 4,500 psi for some coatings.

Typically, there is little or no thermally-induced difference between the powder and the cold spray coating. In other words, what is in the powder is in the coating. Also, typically there is little or no damage to the microstructure of the substrate during cold spray coating. Also, the cold spray coating generally exhibits a cold work microstructure. A high amount of cold work occurs by heavy plastic deformation of the ductile coating materials, which results in a very fine grain structure that can be beneficial for mechanical and corrosion properties of the coating.

Cold spray coating is generally in the compression mode which helps to reduce delamination of the coating as well as macro or microscopic cracking in the coating.

The coating formed by the cold spray coating process may include a mixture of the first material and the second material. The amount of the first material may be about 30-99 vol. % and the amount of the second material may be about 1-70 vol. % in embodiments. Some example amounts of the first material include 30 vol. %, 32 vol. %, 35 vol. %, 38 vol. %, 40 vol. %, 42 vol. %, 45 vol. %, 48 vol. %, 50 vol. %, 52 vol. %, 55 vol. %, 58 vol. %, 60 vol. %, 62 vol. %, 65 vol. %, 68 vol. %, 70 vol. %, 72 vol. %, 75 vol. %, 78 vol. %, 80 vol. %, 82 vol. %, 85 vol. %, 88 vol. %, 90 vol. %, 92 vol. %, 95 vol. %, 98 vol. %, and 99 vol. %. Some example amounts of the second material include 1 vol. %, 2 vol. %, 5 vol. %, 8 vol. %, 10 vol. %, 12 vol. %, 15 vol. %, 18 vol. %, 20 vol. %, 22 vol. %, 25 vol. %, 28 vol. %, 30 vol. %, 32 vol. %, 35 vol. %, 38 vol. %, 40 vol. %, 42 vol. %, 45 vol. %, 48 vol. %, 50 vol. %, 52 vol. %, 55 vol. %, 58 vol. %, 60 vol. %, 62 vol. %, 65 vol. %, 68 vol. %, and 70 vol. %.

At block 315, the process further includes heating the article and coating (e.g., by a furnace). The article and coating may be heated to a temperature between about 200° C. to about 1000° C. The temperature is chosen such that the second material will be removed by pyrolysis or combustion and the first material will be unaffected. At block 320, the process further includes thermally treating (heat treating) the coated article to remove the second material from the coating via pyrolysis. Pyrolysis is a thermal decomposition of materials at elevated temperatures in an inert atmosphere such as a vacuum or an inert gas. Alternatively, the second material may be removed during the heat treatment via combustion in a reactive gas environment such as air or pure oxygen to burn the filler (e.g., to burn a graphics filler). The heat treatment may be performed in a vacuum. Alternatively, the heat treatment may be performed in air or oxygen. In some embodiments, additional reactive gases such as oxygen, ozone, reactive radicals, etc. are pumped into the chamber of the furnace during the heat treatment to expedite the process.

After the pyrolysis (or combustion) is performed at block 320, the second material will have been removed from the coating, leaving behind the first material and pores at the locations formerly occupied by the second material. Accordingly, the coating becomes a porous coating having a precisely controlled porosity and average pore size. The porosity may be based directly on the ratio of the vol. % of the first material to the vol. % of the second material that was in the coating prior to performing the operation of block 320, plus any porosity introduced by the cold spray process (e.g., 1-3%). In particular, the porosity may be based directly on the vol. % of the second material in the coating plus the initial porosity of the cold spray coating. Additionally, the average pore size may be based directly on the average particle diameter of the second powder. Accordingly, the porosity of the porous coating may be around 2-73 vol. % in embodiments. Some example porosities for the porous coating include 2 vol. %, 5 vol. %, 8 vol. %, 10 vol. %, 12 vol. %, 15 vol. %, 18 vol. %, 20 vol. %, 22 vol. %, 25 vol. %, 28 vol. %, 30 vol. %, 32 vol. %, 35 vol. %, 38 vol. %, 40 vol. %, 42 vol. %, 45 vol. %, 48 vol. %, 50 vol. %, 52 vol. %, 55 vol. %, 58 vol. %, 60 vol. %, 62 vol. %, 65 vol. %, 68 vol. %, 70 vol. % and 73 vol. %.

At block 325, the article and coating may then be cleaned via a wet clean or dry clean process to remove any metal contaminants and/or particles from the article and the porous coating.

FIG. 4 illustrates a second process 400 for forming a porous coating with a controlled porosity and pore size according to an embodiment. At block 402, a surface of an article may be roughened or otherwise adjusted. The article may be a component for use in a processing chamber (e.g., of semiconductor manufacturing equipment). For example, the component can be a showerhead, a showerhead base, a cathode sleeve, a sleeve liner door, a cathode base, a chamber liner, an electrostatic chuck, etc. The article may also be a substrate such as a metal mesh framework or a sacrificial substrate that will be removed after the deposition process. The article may be formed from a metal, metal alloy, oxide (e.g., rare earth oxide), nitride or other material. For example, the substrate can be formed from aluminum, aluminum alloys (e.g., Al 6061, Al 5058, etc.), stainless steel, titanium, titanium alloys, magnesium, magnesium alloys, SiN, SiO₂, AlN, Al₂O₃, and so on.

In one embodiment, the average surface roughness of the article is adjusted prior to the formation of the cold spray coating. For example, an average surface roughness of the article may be in a range from about 15 micro-inches to about 300 micro-inches. In one embodiment, the article has an average surface roughness that starts at or that is adjusted to about 120 micro-inches. The average surface roughness may be increased (e.g., by bead blasting or grinding), or may be decreased (e.g., by sanding or polishing). However, the average surface roughness of the article may already be suitable for cold spray coating. Accordingly, average surface roughness adjustment can be optional.

At bock 405, a first powder (coating powder) comprising a first material and a second powder (sacrificial filler powder) comprising a second material are selected. The first powder may be composed of a first material, which may be any of the materials described herein above for the coating powder. The second powder may be composed of a second material, which may be any of the materials described above for the sacrificial filler powder. The first material and the second material may be selected so that the first material as a low or approximately zero etch rate in a particular acid or basic solution and the second material that has a high etch rate in the particular acid or basic solution. Accordingly, the first and second materials may be chosen so that there is a high etch selectivity of the second material over the first material. In one embodiment, the first material is a metal such as stainless steel, aluminum, an aluminum alloy, titanium, a titanium alloy, niobium, a niobium alloy, copper, a copper alloy and so on. In one embodiment, the first material is yttria or a solid solution of Y₂O₃—ZrO₂. In one embodiment, the second material is an oxide such as alumina, yttria or silicon dioxide.

The first material may have a first average particle size (e.g., diameter) and the second material may have a second average particle size (e.g., diameter). The second average particle size of the second material may be selected based on a target average pore size for a porous coating to be formed. A ratio of the vol. % of the first powder and the vol. % of the second powder is selected. The ratio of the amount of first powder to the amount of the second powder will control the ultimate porosity of the porous coating. In one embodiment, the porosity of the coating is approximately equal to the ratio of the vol. % of the first powder to the vol. % of the second powder. In one embodiment, the porosity of the coating is directly correlated to the ratio of the vol. % of the first powder to the vol. % of the second powder, and a model can be generated that correlates the vol. % of the second powder to the final porosity of the coating.

The amount of the first powder may be about 30-99 vol. % and the amount of the second powder may be about 1-70 vol. % in embodiments. Some example amounts of the first material include 30 vol. %, 32 vol. %, 35 vol. %, 38 vol. %, 40 vol. %, 42 vol. %, 45 vol. %, 48 vol. %, 50 vol. %, 52 vol. %, 55 vol. %, 58 vol. %, 60 vol. %, 62 vol. %, 65 vol. %, 68 vol. %, 70 vol. %, 72 vol. %, 75 vol. %, 78 vol. %, 80 vol. %, 82 vol. %, 85 vol. %, 88 vol. %, 90 vol. %, 92 vol. %, 95 vol. %, 98 vol. %, and 99 vol. %. Some example amounts of the second material include 1 vol. %, 2 vol. %, 5 vol. %, 8 vol. %, 10 vol. %, 12 vol. %, 15 vol. %, 18 vol. %, 20 vol. %, 22 vol. %, 25 vol. %, 28 vol. %, 30 vol. %, 32 vol. %, 35 vol. %, 38 vol. %, 40 vol. %, 42 vol. %, 45 vol. %, 48 vol. %, 50 vol. %, 52 vol. %, 55 vol. %, 58 vol. %, 60 vol. %, 62 vol. %, 65 vol. %, 68 vol. %, and 70 vol. %. The selected amounts of the first powder and the second powder are then mixed. The powders can be mixed, for example, by ball milling.

At block 410, the article is loaded into a deposition chamber of a cold spray deposition system (e.g., as described above). A cold spray coating process is then performed to deposit a coating comprising the first material of the first powder and the second material of the second powder onto the article. The cold spray coating can have a thickness in a range from about 1-8 mils or about 1-50 mils (e.g., 0.2 mm, 0.4 mm, 0.5 mm, 1 mm, 2 mm, etc.). In one embodiment, a coating deposition rate can be in a range from about 1 to about 50 grams/min. For example, the coating deposition rate can be in a range from about 1 to about 20 grams/min for the mixed powder.

Application of the cold spray coating can be performed at around 15 degrees C. to about 100 degrees C., depending on the gas temperature, travel speed, and size of the article. In the case of a cold spray deposition, the substrate may not be heated and the application process does not significantly increase the temperature of the substrate being coated.

In one embodiment, the cold spray coating can be very dense, e.g., greater than about 99% density. Further, the cold spray coating can have good adhesion to the substrate without inter-layers, e.g. about 4,500 psi for some coatings.

The coating formed by the cold spray coating process may include a mixture of the first material and the second material. The amount of the first material may be about 30-99 vol. % and the amount of the second material may be about 1-70 vol. % in embodiments. Some example amounts of the first material include 30 vol. %, 32 vol. %, 35 vol. %, 38 vol. %, 40 vol. %, 42 vol. %, 45 vol. %, 48 vol. %, 50 vol. %, 52 vol. %, 55 vol. %, 58 vol. %, 60 vol. %, 62 vol. %, 65 vol. %, 68 vol. %, 70 vol. %, 72 vol. %, 75 vol. %, 78 vol. %, 80 vol. %, 82 vol. %, 85 vol. %, 88 vol. %, 90 vol. %, 92 vol. %, 95 vol. %, 98 vol. %, and 99 vol. %. Some example amounts of the second material include 1 vol. %, 2 vol. %, 5 vol. %, 8 vol. %, 10 vol. %, 12 vol. %, 15 vol. %, 18 vol. %, 20 vol. %, 22 vol. %, 25 vol. %, 28 vol. %, 30 vol. %, 32 vol. %, 35 vol. %, 38 vol. %, 40 vol. %, 42 vol. %, 45 vol. %, 48 vol. %, 50 vol. %, 52 vol. %, 55 vol. %, 58 vol. %, 60 vol. %, 62 vol. %, 65 vol. %, 68 vol. %, and 70 vol. %.

At block 415, the process further includes immersing the article and coating in an acid or basic solution. The acid or basic may be an acid or basic that will selectively etch away the second material without etching the first material or with minimal etching of the first material. For example, if the first material is a metal such as stainless steel and the second material is yttria or alumina, then nitric acid may be used to chemically remove the second material without chemically removing the first material. If the first material is a metal such as stainless steel and the second material is silicon dioxide, then hydrofluoric acid may be used to chemically remove the second material without chemically removing the first material. If the first material is yttria or a solid solution of Y₂O₃—ZrO₂ and the second material is alumina, then phosphoric acid may be used to chemically remove the second material without chemically removing the first material. At block 420, the second material is chemically removed from the coating using the acid solution or basic solution.

After the chemical removal of the second material is performed at block 420, the second material will have been removed from the coating, leaving behind the first material and pores at the locations formerly occupied by the second material. Accordingly, the coating becomes a porous coating having a precisely controlled porosity and average pore size. The porosity may be based directly on the ratio of the vol. % of the first material to the vol. % of the second material that was in the coating prior to performing the operation of block 320. In particular, the porosity may be based directly on the vol. % of the second material in the coating plus an initial porosity of the cold spray coating (e.g., 1-3%). Additionally, the average pore size may be based directly on the average particle diameter of the second powder. Accordingly, the porosity of the porous coating may be around 2-73 vol. %. Some example porosities for the porous coating include 2 vol. %, 5 vol. %, 8 vol. %, 10 vol. %, 12 vol. %, 15 vol. %, 18 vol. %, 20 vol. %, 22 vol. %, 25 vol. %, 28 vol. %, 30 vol. %, 32 vol. %, 35 vol. %, 38 vol. %, 40 vol. %, 42 vol. %, 45 vol. %, 48 vol. %, 50 vol. %, 52 vol. %, 55 vol. %, 58 vol. %, 60 vol. %, 62 vol. %, 65 vol. %, 68 vol. %, 70 vol. % and 73 vol. %.

At block 425, the article and coating may then be cleaned via a wet clean or dry clean process to remove any metal contaminants and/or particles from the article and the porous coating.

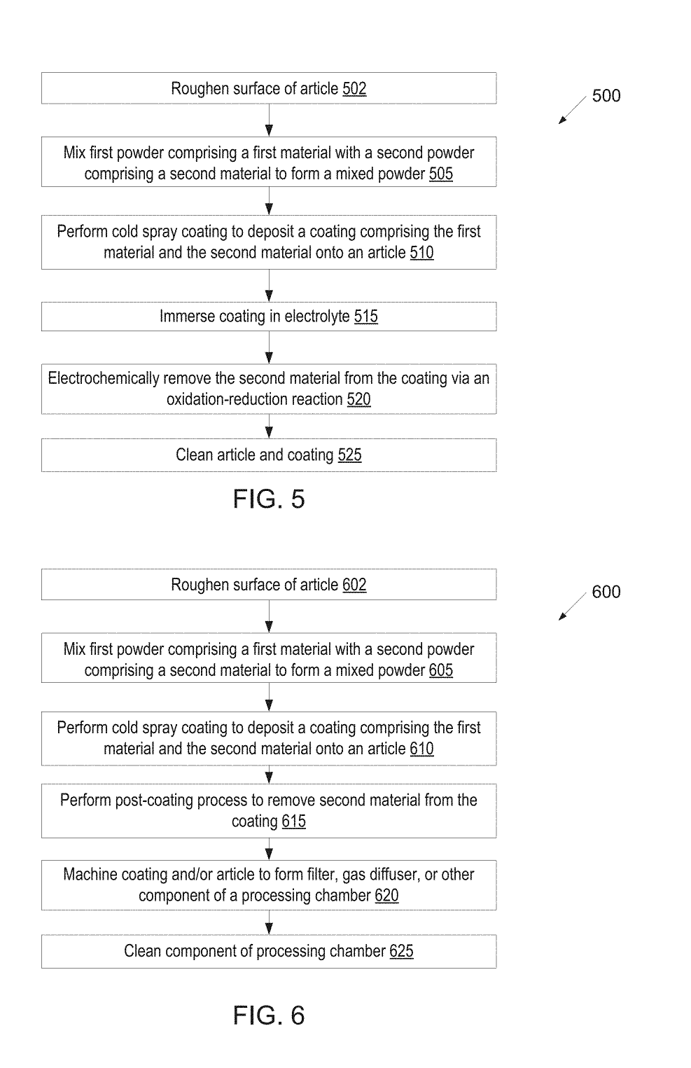

FIG. 5 illustrates a third process 500 for forming a porous coating with a controlled porosity and pore size according to an embodiment. At block 502, a surface of an article may be roughened or otherwise adjusted. The article may be a component for use in a processing chamber (e.g., of semiconductor manufacturing equipment). For example, the component can be a showerhead, a showerhead base, a cathode sleeve, a sleeve liner door, a cathode base, a chamber liner, an electrostatic chuck, etc. The article may also be a substrate such as a metal mesh framework or a sacrificial substrate that will be removed after the deposition process. The article may be formed from a metal, metal alloy, oxide (e.g., rare earth oxide), nitride or other material. For example, the substrate can be formed from aluminum, aluminum alloys (e.g., Al 6061, Al 5058, etc.), stainless steel, titanium, titanium alloys, magnesium, magnesium alloys, SiN, SiO₂, AlN, Al₂O₃, and so on.

In one embodiment, the average surface roughness of the article is adjusted prior to the formation of the cold spray coating. For example, an average surface roughness of the article may be in a range from about 15 micro-inches to about 300 micro-inches. In one embodiment, the article has an average surface roughness that starts at or that is adjusted to about 120 micro-inches. The average surface roughness may be increased (e.g., by bead blasting or grinding), or may be decreased (e.g., by sanding or polishing). However, the average surface roughness of the article may already be suitable for cold spray coating. Accordingly, average surface roughness adjustment can be optional.

At bock 505, a first powder (coating powder) comprising a first material and a second powder (sacrificial filler powder) comprising a second material are selected. The first powder may be composed of a first material, which may be any of the metal materials described herein above for the coating powder. The second powder may be composed of a second material, which may be any of the metal materials described above for the sacrificial filler powder. The first material and the second material may each be metals and may be selected so that the first material has a higher electrode potential than the second material. In one embodiment, the first material is stainless steel and the second metal is zinc or aluminum. In another embodiment, the first material is aluminum or an aluminum alloy and the second material is magnesium, zinc, beryllium or lithium.

The first material may have a first average particle size (e.g., diameter) and the second material may have a second average particle size (e.g., diameter). The second average particle size of the second material may be selected based on a target average pore size for a porous coating to be formed. A ratio of the vol. % of the first powder and the vol. % of the second powder is selected. The ratio of the amount of first powder to the amount of the second powder will control the ultimate porosity of the porous coating. In one embodiment, the porosity of the coating is approximately equal to the ratio of the vol. % of the first powder to the vol. % of the second powder. In one embodiment, the porosity of the coating is directly correlated to the ratio of the vol. % of the first powder to the vol. % of the second powder, and a model can be generated that correlates the vol. % of the second powder to the final porosity of the coating.

The amount of the first powder may be about 30-99 vol. % and the amount of the second powder may be about 1-70 vol. % in embodiments. Some example amounts of the first material include 30 vol. %, 32 vol. %, 35 vol. %, 38 vol. %, 40 vol. %, 42 vol. %, 45 vol. %, 48 vol. %, 50 vol. %, 52 vol. %, 55 vol. %, 58 vol. %, 60 vol. %, 62 vol. %, 65 vol. %, 68 vol. %, 70 vol. %, 72 vol. %, 75 vol. %, 78 vol. %, 80 vol. %, 82 vol. %, 85 vol. %, 88 vol. %, 90 vol. %, 92 vol. %, 95 vol. %, 98 vol. %, and 99 vol. %. Some example amounts of the second material include 1 vol. %, 2 vol. %, 5 vol. %, 8 vol. %, 10 vol. %, 12 vol. %, 15 vol. %, 18 vol. %, 20 vol. %, 22 vol. %, 25 vol. %, 28 vol. %, 30 vol. %, 32 vol. %, 35 vol. %, 38 vol. %, 40 vol. %, 42 vol. %, 45 vol. %, 48 vol. %, 50 vol. %, 52 vol. %, 55 vol. %, 58 vol. %, 60 vol. %, 62 vol. %, 65 vol. %, 68 vol. %, and 70 vol. %. The selected amounts of the first powder and the second powder are then mixed. The powders can be mixed, for example, by ball milling.

At block 510, the article is loaded into a deposition chamber of a cold spray deposition system (e.g., as described above). A cold spray coating process is then performed to deposit a coating comprising the first material of the first powder and the second material of the second powder onto the article. The cold spray coating can have a thickness in a range from about 1-50 mils (e.g., 0.2 mm, 0.4 mm, 0.5 mm, 1 mm, 2 mm, etc.). In one embodiment, a coating deposition rate can be in a range from about 1 to about 50 grams/min. For example, the coating deposition rate can be in a range from about 1 to about 20 grams/min for the mixed powder.

Application of the cold spray coating can be performed at around 15 degrees C. to about 100 degrees C., depending on the gas temperature, travel speed, and size of the article. In the case of a cold spray deposition, the substrate may not be heated and the application process does not significantly increase the temperature of the substrate being coated.

In one embodiment, the cold spray coating can be very dense, e.g., greater than about 99% density. Further, the cold spray coating can have good adhesion to the substrate without inter-layers, e.g. about 4,500 psi for some coatings.

The coating formed by the cold spray coating process may include a mixture of the first material and the second material. The amount of the first material may be about 30-99 vol. % and the amount of the second material may be about 1-70 vol. % in embodiments. Some example amounts of the first material include 30 vol. %, 32 vol. %, 35 vol. %, 38 vol. %, 40 vol. %, 42 vol. %, 45 vol. %, 48 vol. %, 50 vol. %, 52 vol. %, 55 vol. %, 58 vol. %, 60 vol. %, 62 vol. %, 65 vol. %, 68 vol. %, 70 vol. %, 72 vol. %, 75 vol. %, 78 vol. %, 80 vol. %, 82 vol. %, 85 vol. %, 88 vol. %, 90 vol. %, 92 vol. %, 95 vol. %, 98 vol. %, and 99 vol. %. Some example amounts of the second material include 1 vol. %, 2 vol. %, 5 vol. %, 8 vol. %, 10 vol. %, 12 vol. %, 15 vol. %, 18 vol. %, 20 vol. %, 22 vol. %, 25 vol. %, 28 vol. %, 30 vol. %, 32 vol. %, 35 vol. %, 38 vol. %, 40 vol. %, 42 vol. %, 45 vol. %, 48 vol. %, 50 vol. %, 52 vol. %, 55 vol. %, 58 vol. %, 60 vol. %, 62 vol. %, 65 vol. %, 68 vol. %, and 70 vol. %.

At block 515, the process further includes immersing the article and coating in an electrolyte solution such as water with salts (e.g., sodium chloride) dissolved in the water. The electrolyte may also include an acid such as nitric acid. The electrolyte solution may also include hydrogen ions to provide additional electrode potential and speed up an electrochemical reaction. At block 520, the second material is electrochemically removed from the coating via an electrochemical reaction (e.g., a galvanic corrosion reaction).

Dissimilar metals and alloys have different electrode potentials, and when two or more come into contact in an electrolyte, one metal acts as anode and the other as cathode. If the electrolyte contains only metal ions that are not easily reduced (such as Na+, Ca2+, K+, Mg2+, or Zn2+), the cathode reaction is reduction of dissolved H+ to H₂ or O₂ to OH—. The electropotential difference between the reactions at the two electrodes is the driving force for an accelerated attack on the anode metal, which dissolves into the electrolyte. This leads to the metal at the anode corroding more quickly than it otherwise would and corrosion at the cathode being inhibited. The electrolyte provides a means for ion migration where ions move to prevent charge build-up that would otherwise stop the reaction. Acidity or alkalinity (pH) of the electrolyte solution can also be tailored to speed up or slow down the redox reduction.

After the electrochemical removal of the second material is performed at block 520, the second material will have been removed from the coating, leaving behind the first material and pores at the locations formerly occupied by the second material. Accordingly, the coating becomes a porous coating having a precisely controlled porosity and average pore size. The porosity may be based directly on the ratio of the vol. % of the first material to the vol. % of the second material that was in the coating prior to performing the operation of block 320. In particular, the porosity may be based directly on the vol. % of the second material in the coating plus an initial porosity of the cold spray coating. Additionally, the average pore size may be based directly on the average particle diameter of the second powder. Accordingly, the porosity of the porous coating may be around 2-73 vol. %. Some example porosities for the porous coating include 2 vol. %, 5 vol. %, 8 vol. %, 10 vol. %, 12 vol. %, 15 vol. %, 18 vol. %, 20 vol. %, 22 vol. %, 25 vol. %, 28 vol. %, 30 vol. %, 32 vol. %, 35 vol. %, 38 vol. %, 40 vol. %, 42 vol. %, 45 vol. %, 48 vol. %, 50 vol. %, 52 vol. %, 55 vol. %, 58 vol. %, 60 vol. %, 62 vol. %, 65 vol. %, 68 vol. %, 70 vol. % and 73 vol. %.

At block 525, the article and coating may then be cleaned via a wet clean or dry clean process to remove any metal contaminants and/or particles from the article and the porous coating.

FIG. 6 illustrates a process 600 for manufacturing a component of a processing chamber according to embodiments. At block 602, a surface of an article may be roughened or otherwise adjusted. The article may be a porous substrate, a mesh substrate (e.g., a metal mesh framework), a plate with large or small holes, or other substrate through which cases can flow unimpeded. The article may alternatively be a sacrificial substrate that will be cut away after a porous coating is formed thereon. The article may be formed from a metal, metal alloy, oxide (e.g., rare earth oxide), nitride or other material. For example, the substrate can be formed from aluminum, aluminum alloys (e.g., Al 6061, Al 5058, etc.), stainless steel, titanium, titanium alloys, magnesium, magnesium alloys, SiN, SiO₂, AlN, Al₂O₃, and so on.

At bock 605, a first powder (coating powder) comprising a first material and a second powder (sacrificial filler powder) comprising a second material are selected. The first powder may be composed of a first material, which may be any of the materials described herein above for the coating powder. The second powder may be composed of a second material, which may be any of the materials described above for the sacrificial filler powder.

The first material may have a first average particle size (e.g., diameter) and the second material may have a second average particle size (e.g., diameter). The second average particle size of the second material may be selected based on a target average pore size for a porous coating to be formed. A ratio of the vol. % of the first powder and the vol. % of the second powder is selected. The ratio of the amount of first powder to the amount of the second powder will control the ultimate porosity of the porous coating. In one embodiment, the porosity of the coating is approximately equal to the ratio of the vol. % of the first powder to the vol. % of the second powder. In one embodiment, the porosity of the coating is directly correlated to the ratio of the vol. % of the first powder to the vol. % of the second powder, and a model can be generated that correlates the vol. % of the second powder to the final porosity of the coating.

The amount of the first powder may be about 30-99 vol. % and the amount of the second powder may be about 1-70 vol. % in embodiments. Some example amounts of the first material include 30 vol. %, 32 vol. %, 35 vol. %, 38 vol. %, 40 vol. %, 42 vol. %, 45 vol. %, 48 vol. %, 50 vol. %, 52 vol. %, 55 vol. %, 58 vol. %, 60 vol. %, 62 vol. %, 65 vol. %, 68 vol. %, 70 vol. %, 72 vol. %, 75 vol. %, 78 vol. %, 80 vol. %, 82 vol. %, 85 vol. %, 88 vol. %, 90 vol. %, 92 vol. %, 95 vol. %, 98 vol. %, and 99 vol. %. Some example amounts of the second material include 1 vol. %, 2 vol. %, 5 vol. %, 8 vol. %, 10 vol. %, 12 vol. %, 15 vol. %, 18 vol. %, 20 vol. %, 22 vol. %, 25 vol. %, 28 vol. %, 30 vol. %, 32 vol. %, 35 vol. %, 38 vol. %, 40 vol. %, 42 vol. %, 45 vol. %, 48 vol. %, 50 vol. %, 52 vol. %, 55 vol. %, 58 vol. %, 60 vol. %, 62 vol. %, 65 vol. %, 68 vol. %, and 70 vol. %. The selected amounts of the first powder and the second powder are then mixed. The powders can be mixed, for example, by ball milling.

At block 610, the article is loaded into a deposition chamber of a cold spray deposition system (e.g., as described above). A cold spray coating process is then performed to deposit a coating comprising the first material of the first powder and the second material of the second powder onto the article. The cold spray coating can have a thickness in a range from about 1-8 mils or about 1-50 mils (e.g., 0.2 mm, 0.4 mm, 0.5 mm, 1 mm, 2 mm, etc.). In one embodiment, a coating deposition rate can be in a range from about 1 to about 50 grams/min. For example, the coating deposition rate can be in a range from about 1 to about 20 grams/min for the mixed powder.

Application of the cold spray coating can be performed at around 15 degrees C. to about 100 degrees C., depending on the gas temperature, travel speed, and size of the article. In the case of a cold spray deposition, the substrate may not be heated and the application process does not significantly increase the temperature of the substrate being coated.

In one embodiment, the cold spray coating can be very dense, e.g., greater than about 99% density. Further, the cold spray coating can have good adhesion to the substrate without inter-layers, e.g. about 4,500 psi for some coatings.

The coating formed by the cold spray coating process may include a mixture of the first material and the second material. The amount of the first material may be about 30-99 vol. % and the amount of the second material may be about 1-70 vol. % in embodiments. Some example amounts of the first material include 30 vol. %, 32 vol. %, 35 vol. %, 38 vol. %, 40 vol. %, 42 vol. %, 45 vol. %, 48 vol. %, 50 vol. %, 52 vol. %, 55 vol. %, 58 vol. %, 60 vol. %, 62 vol. %, 65 vol. %, 68 vol. %, 70 vol. %, 72 vol. %, 75 vol. %, 78 vol. %, 80 vol. %, 82 vol. %, 85 vol. %, 88 vol. %, 90 vol. %, 92 vol. %, 95 vol. %, 98 vol. %, and 99 vol. %. Some example amounts of the second material include 1 vol. %, 2 vol. %, 5 vol. %, 8 vol. %, 10 vol. %, 12 vol. %, 15 vol. %, 18 vol. %, 20 vol. %, 22 vol. %, 25 vol. %, 28 vol. %, 30 vol. %, 32 vol. %, 35 vol. %, 38 vol. %, 40 vol. %, 42 vol. %, 45 vol. %, 48 vol. %, 50 vol. %, 52 vol. %, 55 vol. %, 58 vol. %, 60 vol. %, 62 vol. %, 65 vol. %, 68 vol. %, and 70 vol. %.

At block 615, the process further includes performing a post-coating material removal process to remove the second material from the coating while leaving behind the first material. The post-coating material removal process may be the heat treatment (e.g., pyrolysis or combustion) process described with reference to process 300, the chemical removal process described with reference to process 400 or the electrochemical removal process described with reference to process 500. The post-coating removal process that is used may depend on the composition of the coating (e.g., on the first material and the second material). The selected process should remove the second material without removing the first material.

Accordingly, the coating becomes a porous coating having a precisely controlled porosity and average pore size. The porosity may be based directly on the ratio of the vol. % of the first material to the vol. % of the second material that was in the coating prior to performing the operation of block 320. In particular, the porosity may be based directly on the vol. % of the second material in the coating plus the initial porosity of the cold spray coating (e.g., 1-3 vol. %). Additionally, the average pore size may be based directly on the average particle diameter of the second powder. Accordingly, the porosity of the porous coating may be around 2-73 vol. %. Some example porosities for the porous coating include 2 vol. %, 5 vol. %, 8 vol. %, 10 vol. %, 12 vol. %, 15 vol. %, 18 vol. %, 20 vol. %, 22 vol. %, 25 vol. %, 28 vol. %, 30 vol. %, 32 vol. %, 35 vol. %, 38 vol. %, 40 vol. %, 42 vol. %, 45 vol. %, 48 vol. %, 50 vol. %, 52 vol. %, 55 vol. %, 58 vol. %, 60 vol. %, 62 vol. %, 65 vol. %, 68 vol. %, 70 vol. % and 73 vol. %.

After the post-coating process is performed at block 615, one or more machining operations may be performed to form a chamber component such as a gas diffuser or a filter from the porous coating. Examples of machining operations include grinding, cutting, polishing, and so on.

If the substrate was a porous substrate, a mesh, a substrate with holes, etc., then the substrate may not be removed from the porous coating. If the substrate was a solid substrate, then the substrate may be removed from the porous coating (e.g., by cutting away the substrate). In one embodiment, the substrate is composed of a material that is also removed during the post-coating removal process. For example, the substrate may be composed of the same material as the second material. In such an embodiment, the substrate may automatically be removed during the post-coating process at block 615.

At block 625, the article and coating may then be cleaned via a wet clean or dry clean process to remove any metal contaminants and/or particles from the article and the porous coating.

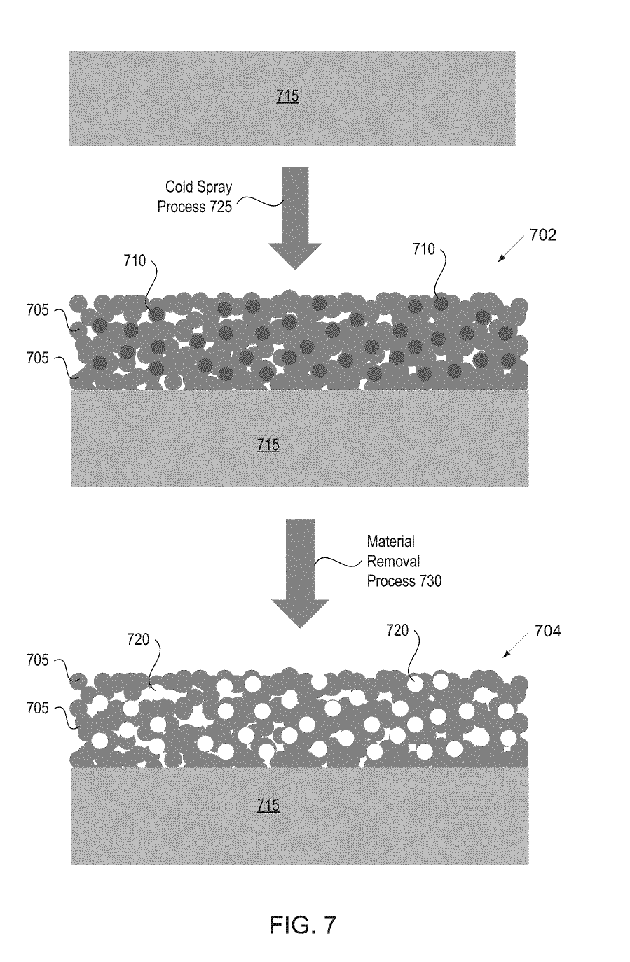

FIG. 7 illustrates various stages of a process for producing a porous coating, according to embodiments. A substrate 715 is provided and placed in a deposition chamber for a cold spray deposition system. A cold spray coating process 725 is then performed by the cold spray deposition system. After the cold spray coating process 725, a coating 702 that includes a first material 705 and a second material 710 is deposited on the substrate 715. The second material 710 is a sacrificial filler material.

A material removal process 730 is then performed to selectively remove the second material 710 without removing the first material from the coating 702. The material removal process 730 may include pyrolysis, combustion, chemical removal or electrochemical removal of the second material. A resultant porous coating 704 is then formed, where a porosity and pore size are based on a vol. % of the second material 710 and the particle size of the second material 710. The porous coating 704 has pores 720 that occupy approximately the same volume previously occupied by the second material 710.

The preceding description sets forth numerous specific details such as examples of specific systems, components, methods, and so forth, in order to provide a good understanding of several embodiments of the present disclosure. It will be apparent to one skilled in the art, however, that at least some embodiments of the present disclosure may be practiced without these specific details. In other instances, well-known components or methods are not described in detail or are presented in simple block diagram format in order to avoid unnecessarily obscuring the present disclosure. Thus, the specific details set forth are merely exemplary. Particular implementations may vary from these exemplary details and still be contemplated to be within the scope of the present disclosure.

Reference throughout this specification to “one embodiment” or “an embodiment” means that a particular feature, structure, or characteristic described in connection with the embodiment is included in at least one embodiment. Thus, the appearances of the phrase “in one embodiment” or “in an embodiment” in various places throughout this specification are not necessarily all referring to the same embodiment. It should be noted that different references to “an” or “one” embodiment in this disclosure are not necessarily to the same embodiment, and such references mean at least one. In addition, the term “or” is intended to mean an inclusive “or” rather than an exclusive “or.” When the terms “about” and “approximately” are used herein, these are intended to mean that the nominal value presented is precise within ±10%.

Although the operations of the methods herein are shown and described in a particular order, the order of the operations of each method may be altered so that certain operations may be performed in an inverse order or so that certain operation may be performed, at least in part, concurrently with other operations. In another embodiment, instructions or sub-operations of distinct operations may be in an intermittent and/or alternating manner.

It is to be understood that the above description is intended to be illustrative, and not restrictive. Many other embodiments will be apparent to those of skill in the art upon reading and understanding the above description. The scope of the disclosure should, therefore, be determined with reference to the appended claims, along with the full scope of equivalents to which such claims are entitled.

What is claimed is:

1. A method comprising:
mixing a first powder comprising a first material with a second powder comprising a second material to form a mixed powder, wherein the mixed powder comprises 30-99 vol. % of the first powder and 1-70 vol. % of the second powder, and wherein the second powder is a sacrificial filler powder;
performing cold spray coating to deposit a coating comprising the first material and the second material onto an article, wherein the coating comprises approximately 30-99 vol. % of the first material and 1-70 vol. % of the second material; and
performing a post-coating process to remove the second material from the coating, wherein after the post-coating process the coating consists essentially of the first material and has a porosity that is approximately equivalent to a volume previously occupied by the second material prior to the post-coating process, wherein the porosity is about 2-73%.

2. The method of claim 1 wherein performing the post-coating process comprises:
heating the coating to an elevated temperature of about 200-1000° C.; and
performing pyrolysis or combustion on the second material to thermally decompose the second material and remove the second material from the coating.

3. The method of claim 2, wherein the first material is a metal selected from a group consisting of stainless steel, aluminum, titanium, an aluminum alloy, and a titanium alloy.

4. The method of claim 2, wherein the second material is a carbon-based material selected from a group consisting of a plastic, an epoxy, graphite, and a polymer.

5. The method of claim 1, wherein the second powder has an average particle size of between 10 nm and 40 microns, and wherein the coating has an average pore size that is approximately equal to the average particle size of the second powder after the post-coating process.

6. The method of claim 5, further comprising:
machining at least one of the article or the coating to form a filter, wherein the filter is configured for placement in a stage of a gas delivery system for a processing chamber that flows one or more gasses, and wherein the filter is to filter out particles in the one or more gasses.

7. The method of claim 6, wherein machining the article comprises cutting away the article from the coating.

8. The method of claim 5, wherein the article is selected from a group consisting of a metal mesh, a substrate comprising a plurality of holes, and a porous substrate.

9. The method of claim 8, wherein the coating and the article together form a gas diffuser for a processing chamber, wherein pores in the coating evenly distribute gases that pass through the gas diffuser.

10. The method of claim 1, wherein performing the post-coating process comprises:
immersing the coating in an acid solution, wherein the acid solution is selected from a group consisting of nitric acid, phosphoric acid, hydrochloric acid, and hydrofluoric acid; and
chemically removing the second material from the coating using the acid solution.

11. The method of claim 10, wherein the second material is selected from a group consisting of alumina, silicon oxide, and yttria.

12. The method of claim 1, wherein the first material is a first metal having a first electrode potential and the second material is a second metal having a second electrode potential that is lower than the first electrode potential, and wherein performing the post-coating process comprises:
immersing the coating in an electrolyte; and
removing the second material from the coating via an electrochemical reaction.

13. The method of claim 12, wherein the electrochemical reaction is a galvanic reaction.

14. A component for a processing chamber, comprising:
a substrate; and
a porous coating on the substrate, wherein:
the porous coating consists of a metal or a metal oxide;
the porous coating has a thickness of approximately 1-8 mils;
the porous coating has a porosity of about 1-70%; and
the porous coating has an average pore size of about 10 nm to about 40 microns.

15. The component of claim 14, wherein the component was manufactured by a process comprising:
mixing a first powder comprising the metal or the metal oxide with a second powder comprising a second material to form a mixed powder, wherein the mixed powder comprises 30-99 vol. % of the first powder and 1-70 vol. % of the second powder, and wherein the second powder is a sacrificial filler powder;
performing cold spray coating to deposit a coating comprising the metal or the metal oxide and the second material onto the metal mesh frame, wherein the coating comprises approximately 30-99 vol. % of the first material and 1-70 vol. % of the second material; and
performing a post-coating process to remove the second material from the coating and transform the coating into the porous coating, wherein after the post-coating process the porous coating consists essentially of the metal or the metal oxide and has a porosity that is approximately equivalent to a volume previously occupied by the second material prior to the post-coating process.

16. The component of claim 14, wherein the porous coating is selected from a group consisting of stainless steel, aluminum, an aluminum alloy, magnesium, a magnesium alloy, titanium, a titanium alloy, niobium, and a niobium alloy.

17. The component of claim 14, wherein the component is a filter for a gas delivery system of the processing chamber.

18. The component of claim 14, wherein the component is a gas diffuser.

19. The component of claim 14, wherein the substrate is selected from a group consisting of a metal mesh, a substrate comprising a plurality of holes, or a porous substrate.

20. A filter or diffuser for a gas delivery system, comprising:
a porous body consisting of a metal or a metal oxide, the porous body having a thickness of approximately 1-8 mils, a porosity of about 1-70%, and an average pore size of about 10 nm to about 40 microns, the porous body having been formed by a method comprising:
mixing a first powder comprising the metal or the metal oxide with a second powder comprising a second material to form a mixed powder, wherein the mixed powder comprises 30-99 vol. % of the first powder and 1-70 vol. % of the second powder, and wherein the second powder is a sacrificial filler powder;
performing cold spray coating to deposit a coating comprising the metal or the metal oxide and the second material onto a substrate, wherein the coating comprises approximately 30-99 vol. % of the metal or metal oxide and 1-70 vol. % of the second material;
performing a post-coating process to remove the second material from the coating and transform the coating into the porous body, wherein after the post-coating process the porous body consists essentially of the metal or the metal oxide and has a porosity that is approximately equivalent to a volume occupied by the second material prior to the post-coating process; and
removing the substrate from the porous body.
